(19) United States
(12) Patent Application Publication
(10) Pub. No.: US 2003/0110115 A1
(43) Pub. Date: Jun. 12, 2003

(54) Change management system, change management server, change management method, and change management program

(75) Inventors: Yoshiki Abe, Kawasaki (JP); Kiyotaka Awatsu, Kawasaki (JP); Hidehiko Yamamoto, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,736

(22) Filed: Mar. 22, 2002

(30) Foreign Application Priority Data
Dec. 11, 2001 (JP) 2001-376785

(51) Int. Cl. G06F 17/60

(52) U.S. Cl. 705/36

(57) ABSTRACT

A change management system and method or the like are provided which are capable of permitting purchasers to easily perform the management of changes by effectively utilizing the change for investments, thereby improving the benefits of the purchasers as well as activating purchase dealings. In the change management method for managing changes through investments by using a computer and a network, data on the changes and persons who should receive the changes is registered as change data. When an investment server 14 receives information on investments to be made from an ATM terminal 2 or the like, access is made to investment-related management enterprise side systems 8-12 based on this information, so that prescribed investment processing is carried out by the investment-related management enterprise side systems 8-12 while using electronic data.

### BACKGROUND OF THE INVENTION

1. Field of the Invention

The present invention relates to a change management system, a change management server, a change management method, and a change management program for enabling customers to invest changes without receiving them upon each purchase and to receive returns on investments.

2. Description of the Prior Art

As systems for managing changes, there have been known Japanese Patent Application Laid-Open No. 8-329340 and Japanese Patent Application Laid-Open No. 10-340387, for example. One of these publications, i.e., Japanese Patent Application Laid-Open No. 8-329340, is intended to achieve improvements in the earnings of retail stores and the like by eliminating the handling of cash for changes in retail stores, shops in the retail trade to reduce their running funds, as well as eliminating the work of paying back changes to customers thereby to shorten the purchasing times to increase the customer's turnover rate. The system for managing changes described in Japanese Patent Application Laid-Open No. 8-329340 includes a personal information recording means in which personal information on purchasers is recorded; a money registration means which calculates an amount of change based on purchaser's identification information from the personal information recording means, the amount of purchasing money, and the amount of payment from each purchaser, and determines and registers the amount of money to be paid back from the store side to the purchaser side, and a balance amount of paid-back money which is the difference between the amount of change and the amount of money to be paid back to the purchaser side, adds up the balance amounts of paid-back money for each purchaser, allots the balance amounts of paid-back money thus added up to the amount of purchasing money that each purchaser should pay, calculates and updates a cumulative balance sum of the balance amounts of paid-back money for each individual purchaser whenever there takes place buying and selling; and a balance paid-back money stock means which collectively administers the balance of paid-back money in each retail store.

In addition, Japanese Patent Application Laid-Open No. 10-340387 is intended to eliminate the complexity or troublesomeness of handling changes in purchases, and to reduce the preparatory or reserve funds of changes in the form of small changes or coins. A change management system disclosed in this publication includes a cash register and a host computer in which when a customer makes a purchase by using a change card storing therein a prescribed amount of money beforehand, a change is calculated by subtracting the purchasing money from the cash paid by the customer at the cash register, and an amount of change less than the prescribed amount of money preset in the change card is recorded or stored in the change card upon each purchase, and an amount of money in excess of the prescribed amount of money is paid to the customer as a change upon each purchase.

In any of the change management systems disclosed in the above-mentioned publications, it is possible to avoid the troublesomeness of making payment upon purchasing.

However, changes are treated as the changes that the purchaser should receive in any case in the conventional techniques as described above. For instance, changes have only been treated as change data during the time from the generation of the changes to the receipt thereof. However, if there is a technique capable of effectively utilizing or managing such changes until they are actually paid back to the customers, money in the form of the changes of purchasers will be effectively operated or managed. As a result, the benefits of the purchasers can be improved and their purchasing desires can be increased. In addition, it is possible to activate trading or purchase dealings, thus contributing greatly to industrial developments.

### SUMMARY OF THE INVENTION

The present invention is based on various demands as referred to above, and has for its object to provide a change management system, a change management server, a change management method, and a change management program which are capable of making effective use of changes in investments so as to expedite purchasers' easy management or operation thereof, thus improving purchasers' benefits and activating purchase dealings.

Bearing the above object in mind, according to a first aspect of the present invention, there is provided a change management system which includes: a change data input part for inputting, as change data, data related to changes and persons who should receive the changes; a change data registration part for registering the change data input by the change data input part; and an investment processing part for performing prescribed investment processing using electronic data based on the change data registered by the change data registration part.

With this arrangement, purchasers can effectively utilize changes in investments whereby purchasers' management of the changes can be carried out easily. As a result, it is possible to enhance purchasers' benefits and activate purchase dealings as well. Here, note that in one embodiment, the change data input part is constituted by a POS terminal 1, an ATM terminal 2 and a vending machine terminal 3, etc. Also, the change data registration part is constituted by a customer database 504, and the investment processing part is constituted by an investment server 14.

In a preferred form of the first aspect of the present invention, the investment processing part includes: an investment information data preparation part for preparing investment information data for prescribed investments based on the change data registered in the change data registration part; and an administration part for administering the investment information data prepared by the investment information data preparation part.

With this arrangement, the management of the results of investments can be automatically performed, thus making the investment processing extremely easy. In the embodiment, the investment information data preparing part is constituted by an investment information data preparation part 505 of the investment server 14, and the administration part is constituted by an administration part 506 of the investment server 14.

In another preferred form of the first aspect of the present invention, the administration part includes an investment payment processing part for performing payment processing on investments by using electronic data based on the investment information data prepared by the investment information data preparation part.

With this arrangement, returns on the investments can be easily paid out. Note that in the embodiment, the investment payment processing part is constituted by an investment payment processing part 511 of the administration part 506.

In a further preferred form of the first aspect of the present invention, the change management system further includes a management information instruction part for instructing management information on the changes, and the investment information data preparation part prepares the investment information data based on the change data registered in the change data registration part and the management information instructed by the management information instruction part.

With this arrangement, changes can be treated based on the management information, thus making it possible to perform various management such as selection of the kinds or types of investments and so on for improved interest in the change management. Note that in the embodiment, the management information instruction part is constituted by the ATM terminal 2, a customer terminal 7 and a terminal operation screen data supplying part 515 of the investment server 14.

In a still further preferred form of the first aspect of the present invention, the management information instruction part includes a selection part for enabling the persons, who should receive the changes, to select, as investors, one or more investment types among a plurality of different investment types. With this arrangement, it becomes easy for the persons to select the types of investments and to carry out the thus selected investments. Note that in the embodiment, the selection part is constituted by terminals such as the ATM terminal 2, the customer terminal 7 and the like, and the terminal operation screen data supplying part 515 of the investment servers 14.

In a yet further preferred form of the first aspect of the present invention, the plurality of investment types include savings, exchange purchases, stock purchases, horse race ticket purchases and lottery purchases.

In a further preferred form of the first aspect of the present invention, the administration part includes: an investment information registration part for registering the investment information data; and an investment payout processing part for paying out returns on the investments for recovery thereof based on the investment information data registered in the investment information registration part or the investment information data and prescribed instructions of the investors.

With this arrangement, the management of investments is carried out based on the investment information, and it becomes possible to easily perform the recovery of investments based on the management data and instructions from investors or the like in the form of those who should receive the changes for example. Note that in the embodiment, the investment information registration part is constituted by an investment customer database 508 and an investment database 510 of the administration part 506.

In a further preferred form of the first aspect of the present invention, the change management system further includes a return distribution processing part for distributing data of amounts of money to be paid out by the investment payout processing part to a plurality of investors based on the investment information data registered in the investment information registration part.

With this arrangement, in cases where an investment has been made by a plurality of investors, it is possible to distribute a return on the investment to the respective investors who made the investment, so collective investments by two or more persons can be made, thus making it possible to expand the range of change management. Note that in the embodiment, the return distribution processing part is constituted by a return distribution processing part 513 of the administration part 506.

In a further preferred form of the first aspect of the present invention, the investment information data preparation part includes a first change totaling part for totaling amounts of changes to be received by a prescribed person, and the investment information data preparation part prepares the investment information data based on a total sum of the changes totaled by the first change totaling part.

This arrangement serves to make it possible to carry out Investments by collecting respective customers' changes together. Note that in the embodiment, the first change totaling part is constituted by a first change data totaling part 505a of the investment information data preparation part 505.

In a further preferred form of the first aspect of the present invention, the investment information data preparation part includes a second change totaling part for totaling the changes to be received by a plurality of different prescribed persons, and the investment information data preparation part prepares the investment information data based on a total sum of the changes totaled by the second change totaling part.

This arrangement serves to make it possible to carry out collective investments by two or more persons, whereby the range of change management can be further expanded, contributing to more effective use of the changes. Note that in the embodiment, the second change totaling part is constituted by a second change data totaling part 505b of the investment information data preparation part 505

According to a second aspect of the present invention, there is provided a change management system which includes: a change data input terminal for inputting, as change data, data related to changes and persons who should receive the changes; a change data registration database connected with the change data input terminal for registering therein the change data input by the change data input terminal; an instruction information input terminal for inputting prescribed instruction information on the management of the changes; and an investment processing server connected with the change data input terminal, the instruction information input terminal, the change data registration database, and an investment-related management enterprise side computer for performing the management of investments, the investment processing server being operable to perform prescribed investment procedures based on the change data registered in the change data registration database and instruction information input from the instruction information input terminal.

With such an arrangement, it becomes possible to widely apply this change management system of the invention through the use of communications means such as the Internet, etc.

According to a third aspect of the present invention, there is provided a change management server for managing changes through investments thereof, which is connected with an investment-related management enterprise side computer and an information terminal through a communications network for performing the management of investments. The change management server includes: a registration part for registering, as change data, data related to changes and persons who should receive the changes, transmitted from the information terminal; and an investment processing part adapted to access, upon receipt of prescribed instruction information on the management of the changes from the information terminal, the investment-related management enterprise side computer and perform investment processing by using electronic data based on the prescribed instruction information and the change data registered in the registration part.

According to a fourth aspect of the present invention, there is provided a change management program for making a change management server, which is connected with an information terminal and an investment-related management enterprise side computer for the management of investments through a communications network, perform the processing of managing changes through investments thereof. The program includes: a first step for registering data related to changes and persons who should receive the changes, transmitted from the information terminal in a registration part as change data; a second step for accessing, upon receipt of prescribed instruction information on the management of the changes from the information terminal, the investment-related management enterprise side computer to perform investment processing by using electronic data based on the prescribed instruction information and the change data registered in the registration part; and a third step for making the change management server perform the first and second steps.

According to a fifth aspect of the present invention, there is provided a change management method for managing changes through investments thereof by using a computer and a communications network. The change management method includes the steps of: registering data related to changes and persons who should receive the changes as change data; receiving prescribed information on the management of the changes; accessing an investment-related management enterprise side computer based on the prescribed information; and performing prescribed investment processing on the investment-related management enterprise side computer by using electronic data based on the prescribed information on the management of the changes and the registered change data.

In a preferred form of the fifth aspect of the present invention, the step for performing prescribed investment processing includes: an investment information data preparing step for preparing investment information data for prescribed investments based on the information on the management of the changes and the registered change data; and a payment processing step for performing payment processing on investments by using electronic data based on the investment information data prepared in the investment information data preparing step.

In another preferred form of the fifth aspect of the present invention, the change management method further includes: an investment information registration step for registering the investment information data; and an investment payout step for performing investment payout processing for recovery of investments by using electronic data based on the investment information data registered in the investment information registration step or the investment information data and the prescribed information.

In a further preferred form of the fifth aspect of the present invention, the change management method further includes a distribution step for distributing data on the amounts of money paid out in the investment payout step to a plurality of investors based on the investment information data.

According to a sixth aspect of the present invention, there is provided a change processing terminal equipment which includes: a first selection part for permitting a person to make a selection as to whether a change, which is generated upon payment of an amount of money, is to be paid back or invested; and a change processing part for performing prescribed processing to invest and manage the change when the first selection part makes a selection such that the change is managed through investments.

In a preferred form of the sixth aspect of the present invention, the change processing terminal equipment further includes a second selection part for permitting, upon the management of the change through investments being selected by the first selection part, the person to make a selection about the types of investments in response to the result of the selection of investments, wherein the change processing part performs prescribed processing on the management of the types of investments selected.

In another preferred form of the sixth form of the present invention, the prescribed processing is to transmit change data on the person who should receive the change and an amount of the change to a prescribed device which manages the change through investments.

The above and other objects, features and advantages of the present invention will become more readily apparent to those skilled in the art from the following detailed description of A preferred embodiment of the present invention taken in conjunction with the accompanying drawings.

### BRIEF DESCRIPTION OF THE DRAWINGS

FIG. 1 is a block diagram illustrating the overall arrangement of a change management system according to the present invention.

FIG. 2 is a block diagram illustrating a change management server in one embodiment of the present invention.

FIG. 3 is a conceptual view illustrating the operation of a change data registration step according to the present invention.

FIG. 4 is a conceptual view illustrating the operation of an investment step according to the present invention.

FIG. 5 is a conceptual view illustrating the operation of an investment result notification and reference (inquiry) step according to the present invention.

FIG. 6 is a conceptual view illustrating the operation of an investment result reflection and distribution step according to the present invention.

FIG. 7 is a conceptual view illustrating the operation of an investment payout step according to the present invention.

FIG. 8 is a flow chart illustrating the investment step according to the present invention.

FIG. 9 is a flow chart illustrating the investment result notification and reference (inquiry) step according to the present invention.

FIG. 10 is a flow chart illustrating the investment result reflection and reference (inquiry) step according to the present invention.

FIG. 11 is a flow chart illustrating the investment payout step according to the present invention.

FIG. 12 is a view illustrating registered or recorded data in a customer database according to the present invention.

FIG. 13 is a view illustrating registered or recorded data in an investment customer database according to the present invention.

FIG. 14 is a view illustrating registered or recorded data in an investment database according to the present invention.

FIG. 15 is a view illustrating an ATM operation starting screen according to the present invention.

FIG. 16 is a view illustrating a beverage purchasing screen according to the present invention.

FIG. 17 is a view illustrating a purchasing article confirmation screen according to the present invention.

FIG. 18 is a view illustrating a change investment requesting screen according to the present invention.

FIG. 19 is a view illustrating an investment type selection screen according to the present invention.

FIG. 20 is a view illustrating a lottery purchasing screen according to the present invention.

FIG. 21 is a view illustrating a foreign currency purchasing screen according to the present invention.

FIG. 22 is a view illustrating a deficient money amount displaying screen according to the present invention.

FIG. 23 is a view illustrating an number-of-units confirmation screen according to the present invention.

FIG. 24 is a view illustrating an investment money amount input screen according to the present invention.

FIG. 25 is a view illustrating an investment request ending screen according to the present invention.

FIG. 26 is a view illustrating a balance reference (inquiry) screen (1) according to the present invention.

FIG. 27 is a view illustrating a balance reference (inquiry) screen (2) according to the present invention.

FIG. 28 is a view illustrating a password input screen according to the present invention.

FIG. 29 is a view illustrating a payout money amount input screen according to the present invention.

FIG. 30 is a view illustrating a balance-after-transfer displaying screen according to the present invention.

FIG. 31 is a view illustrating a continued payout confirmation screen according to the present invention.

FIG. 32 is a view illustrating a money box investment receipt sample according to the present invention.

FIG. 33 is a view illustrating a payout receipt sample according to the present invention.

### DESCRIPTION OF THE PREFERRED EMBODIMENT

Now, a preferred embodiment of the present invention will be described below in detail while referring to the accompanying drawings.

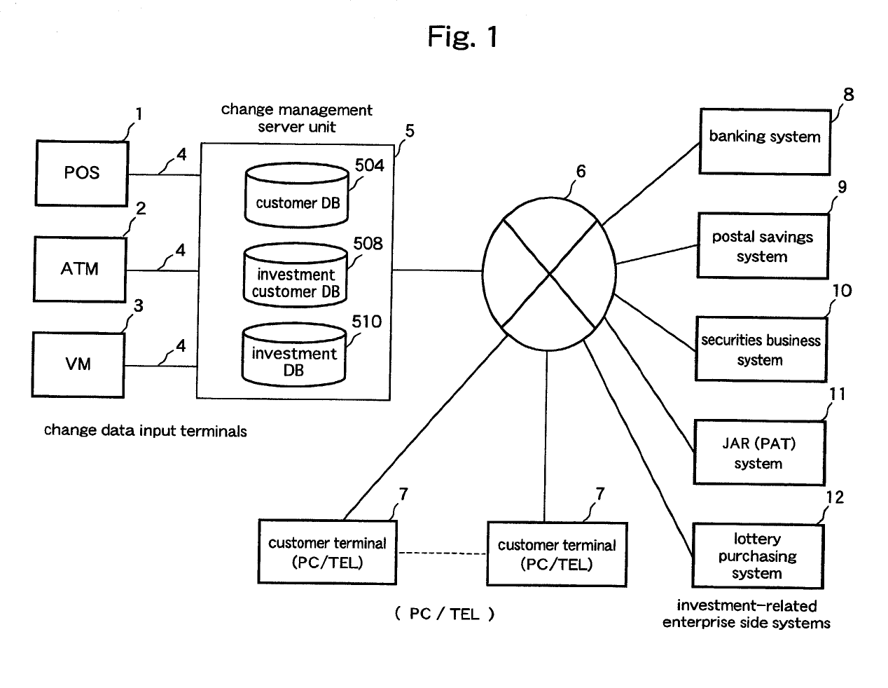

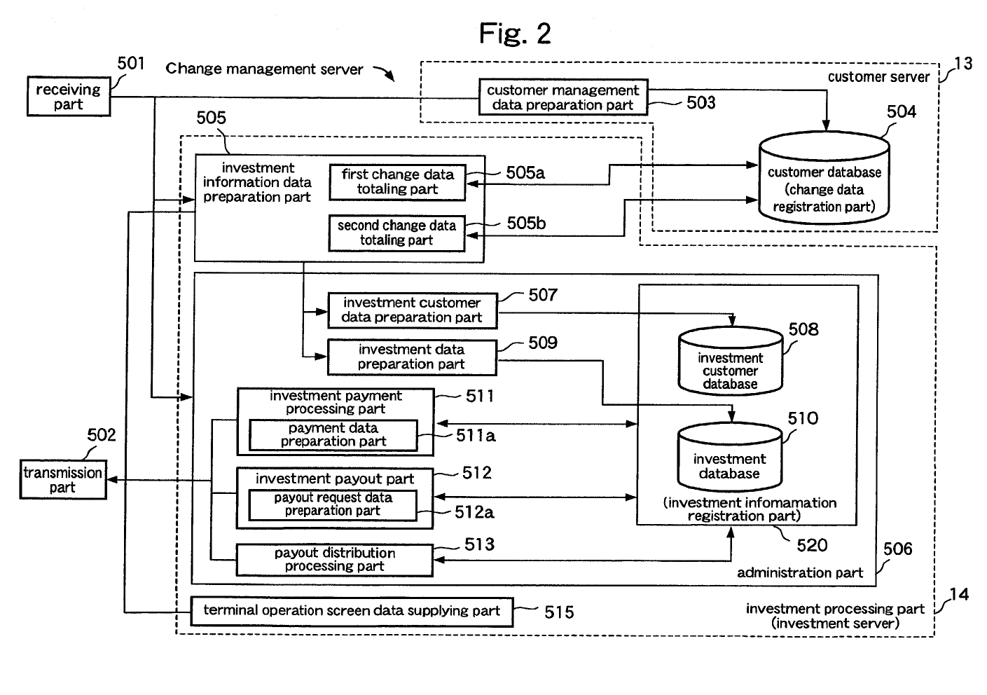

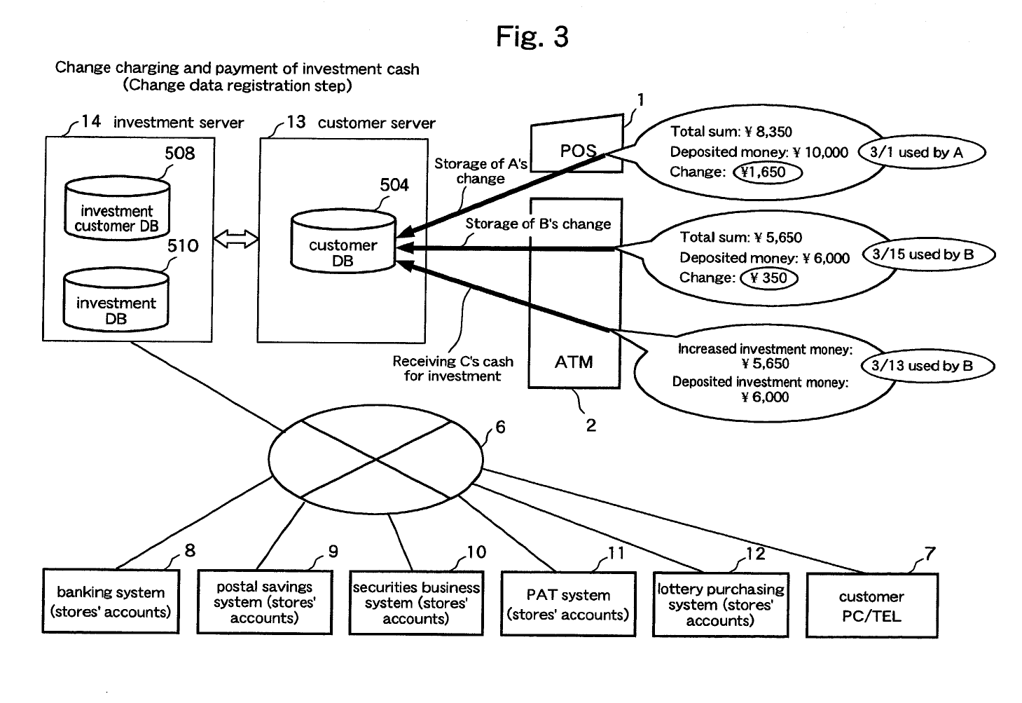

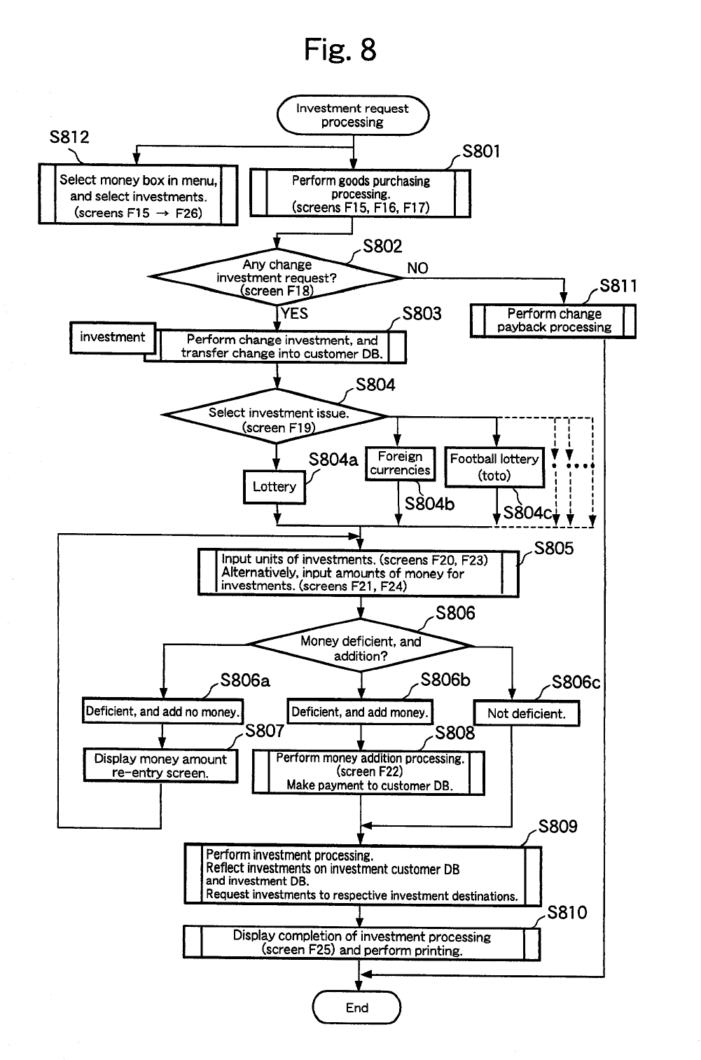

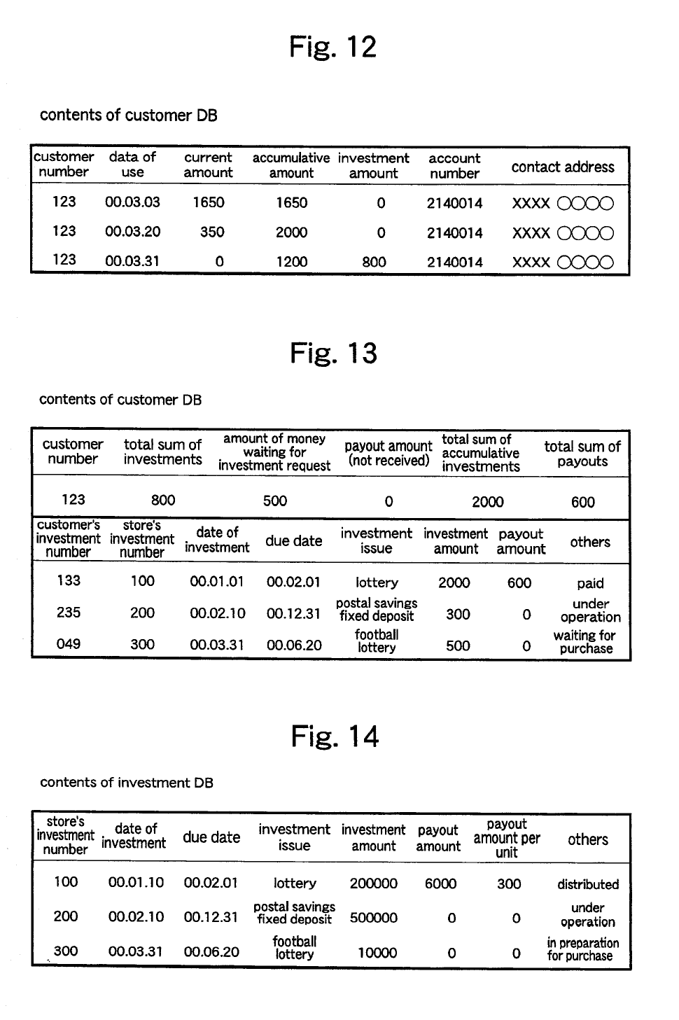

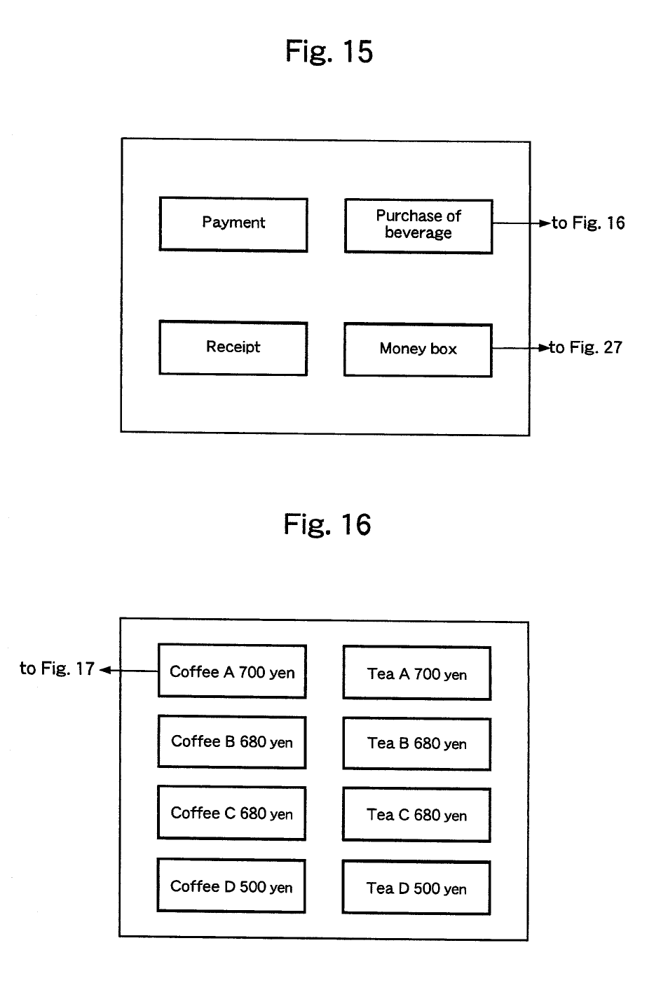

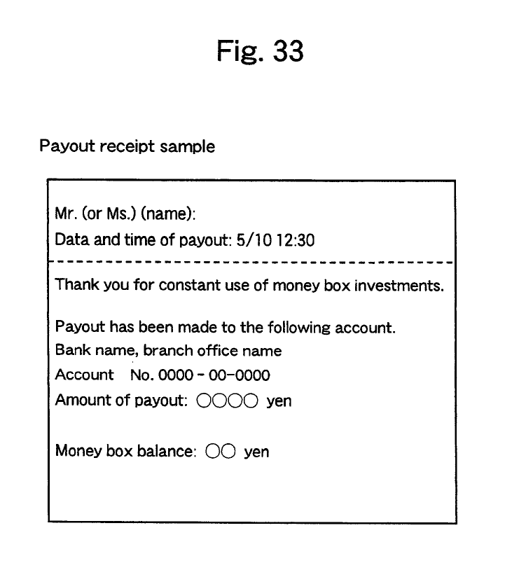

FIG. 1 shows the overall arrangement of a change management system according to one embodiment of the present invention. FIG. 2 shows the arrangement of a change management server. FIG. 3 through FIG. 7 show the operation of the change management system according to this embodiment. FIG. 8 through FIG. 11 are flow charts which show the operation of the change management system according to this embodiment. FIG. 12 through FIG. 14 show data stored in databases. FIG. 15 through FIG. 31 show various operation screens at terminals. FIG. 32 and FIG. 33 show receipt samples.

The change management system according to this embodiment includes a plurality of terminal devices in the form of change data input terminals such as a POS terminal 1, an ATM terminal 2, a VM terminal 3 and so on installed in a POS (Point of Sales System), an ATM (Automatic Teller Machine), a VM (Vending Machine), etc., for transmitting the amounts of changes as change data together with investment information to be described later through a communications network 4 (private or leased lines, a public network, the Internet, etc.); a change management server 5 connected with these terminals 1-3 for managing the changes; and a plurality of customer terminals 7 and a plurality of investment-related management enterprise side systems (i.e., computers) all connected with the change server 5 through a network 6 such as the Internet. The investment-related management enterprise side systems include a banking system 8, a postal savings system 9, a securities trading system 10, a JRA (Japan Racing Association) system 11 (PAT system), a lottery purchasing system 12 and so on. Here, note that it is presupposed that the customers in this embodiment are registered as members, and qualified to use this change management system.

The change management server 5 includes, as shown in detail in FIG. 2, a receiving part 501 connected with the communications network 6 for receiving data and a transmission part 502 connected with the communications network 6 for transmitting data, a customer administration data preparation part 503 adapted to receive change data from the change data input terminals 1-3 and prepare customer management data based on the change data received, a customer database 504 (change data registration or storage part) for registering or storing the data prepared by the customer administration data preparation part 503, an investment information data preparation part 505 for preparing investment information data based on the investment information input from the customer terminals 7 and the change data input terminals 1-3 and the customer data registered or recorded in the customer database 504, an administration part 506 for administering investment information data prepared by the investment information data preparation part 505, and a terminal operation screen data supplying part 515 for displaying operation screens on the change data input terminals 1-3 and the customer terminals 7 as necessary. The investment information data preparation part 505 includes a first change data totaling part 505a for totaling the changes of each prescribed customer, and a second change data totaling part 505b for totaling the changes of a plurality of different customers.

The administration part 506 includes an investment customer data preparation part 507 for preparing data used to administer invested customers based on the investment information prepared by the investment information data preparation part 505, an investment customer database 508 for registering or storing data prepared by the investment customer data preparation part 507, an investment data preparation part 509 for preparing investment data used to manage the contents of investment based on the investment information, and an investment database 510 for registering or storing the investment data prepared by the investment data preparation part 509. The investment customer database 508 and the investment database 510 together constitute an investment information registration part 520.

In addition, the administration part 506 includes an investment payment processing part 511 having a payment data preparation part 511a for preparing payment data as electronic data so as to make payment for objects to be invested, an investment payout processing part 512 having a payout request data preparation part 512a for preparing payout request data as electronic data so as to pay out returns on investments for recovery thereof, and a return distribution processing part 513 for distributing the amounts of money for investment returns to a plurality of investors who invested their changes.

The change management server 5 as shown in FIG. 2 may be of the divided construction including a customer server 13 for administering change data from customers and an investment server 14 for processing the investments of the customers, as illustrated by dotted lines in FIG. 2. If the change management server 5 is constructed such that it is divided into the customer server 13 and the investment server 14, the load of the change management server 5 can be distributed to these component servers so that the load on each component server 13, 14 is reduced as compared with the case the change management server 5 is constituted by a single server. In this case, the customer server 13 and the investment server 14 may share a receiving part 15 and a transmission part 16, as shown in the drawings, or may be each provided with them. In the following description of the operation of this embodiment, FIG. 3 through FIG. 7 illustrate the case where the change management server 5 is constituted by the customer server 13 and the investment server 14.

Hereinafter, the operation of this embodiment will be schematically described while referring to FIG. 3 through FIG. 7. FIG. 3 conceptually illustrates a registration or recording step for registering or recording change data at the initial stage of the change management. In FIG. 3, when a change is generated at the POS terminal 1 or the ATM terminal 2, a customer registers or records the data of the change in the customer database 504 through the customer server 13 according to the customer's desire. For instance, in case of person A, when the person A pay 10,000 yen for payment of 8,350 yen at the POS terminal 1, he or she will receive a change of 1,650 yen, but the change is temporarily registered or recorded for investments without being directly paid back. This is the same for persons B and C.

In the customer database 504, as shown in FIG. 12, there are registered such data as numbers attached to respective customers (customer numbers), the dates of registration of change data (dates of use), the amount of change (amount of current change), the total amount of change (accumulative amount of change), the amounts of invested money, account numbers, and contact addresses (for instance, e-mail addresses), etc. Thus, changes occurring on the customer side are stored and accumulated in each case as change data in the customer database 504 based on the customer's will. The data registered in the customer database 504 is prepared by the customer administration data preparation part 503, as shown in FIG. 2.

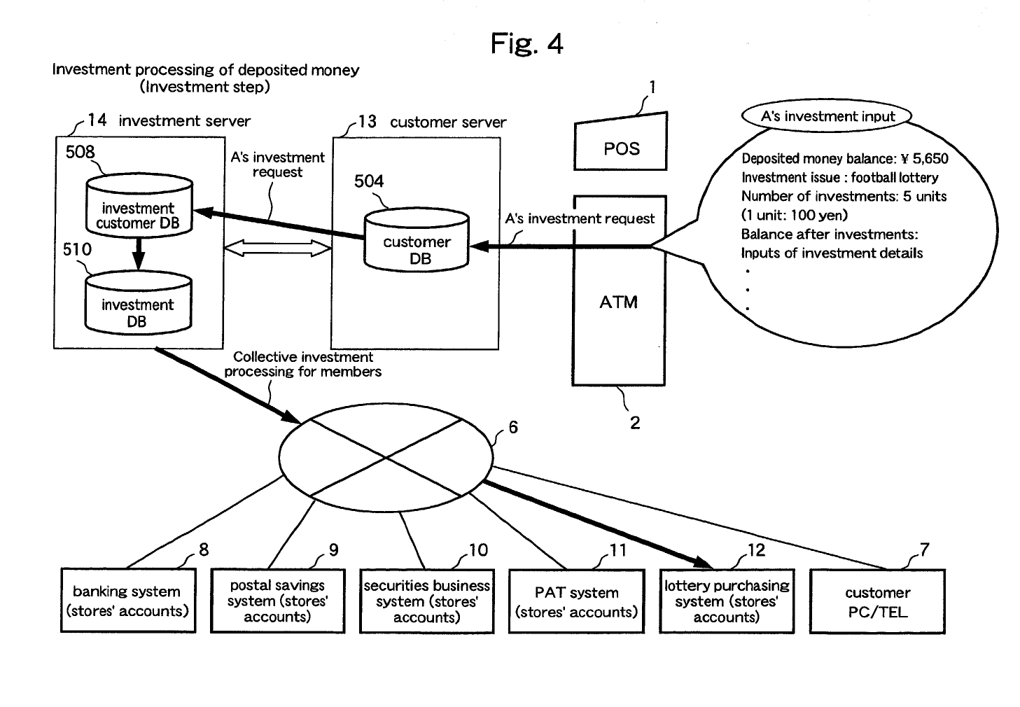

FIG. 4 conceptually illustrates an investment step for presenting customer's intention for investments, and performing investments based on change data stored in the customer database 504. In FIG. 4, the person A purchases five units of football lotteries (one unit: 100 yen) from the deposit balance (accumulative amount of unused changes) by using the ATM terminal 2. The investment information indicating A's investment intention is transmitted from the ATM terminal 2 to the investment server 14 (investment processing part) through the customer server 13. In the investment server 14, data of investment information (lottery purchasing information) for purchasing football lotteries is prepared by the investment information data preparation part 505 based on data in the customer database 504, and then transmitted to the lottery purchasing system 12 through the network 6. The investment information data preparation part 505 can also prepare data for purchasing a total or large number of lotteries from the collected change data of a plurality of customers, or it can prepare the purchase data for each customer, as required. That is, according to the change management system of the present invention, respective pieces of change data can be collected for cooperative purchases, or pieces of change data can be individually used for personal purchases depending upon the sizes thereof. The totaling of pieces of change data (total amount) for each customer is carried out by the first change data totaling part 505a, and pieces of change data for a plurality of customers are totaled by the second change data totaling part 505b. Here, it is assumed that football lotteries are jointly bought by a plurality of customers.

On the other hand, in the administration part 506 of the investment server 14, the investment customer data preparation part 507 prepares investment customer data for administering the invested customers based on the investment information data, and the data thus prepared is stored in the investment customer database 508. FIG. 13 illustrates the investment customer data stored in the investment customer database 508. The total amount of invested money, the amount of money waiting for investment requests, the amount of payout (paid back) money, the total amount of historical (accumulative) investments, and the total amount of historical payout (paid back) money for each customer number are stored in the investment customer database 508. At the same time, the customer's investment number, the store's investment number (investment-related management enterprise side system number), the dates of investments, the due (maturity) dates, investment issues (stocks), amounts of invested money, amounts of payout money, and others such as historical states for each customer's number are stored in the investment customer database 508. In addition, the investment data preparation part 509 prepares investment data for administering the contents of investments such as investment items, amounts of investments, etc., based on the investment information data, and the data thus prepared is stored in the investment database 510. FIG. 14 illustrates the contents of investments stored in'the investment database 510. The store's investment numbers, the dates of investments, the due (maturity) dates, investment issues (stocks), amounts of invested money, amounts of payouts, the amount of payout per unit of investment, and others items such as historical states are stored in the investment database 510.

Moreover, in this investment request, payment data is prepared as electronic data based on the investment information, and transmitted to the lottery purchasing system 12 so that the investment payment processing part 511 of the administration part 506 can pay out returns on the investments. The payment data is prepared by the payment data preparation part 511a in the investment payment processing part 511.

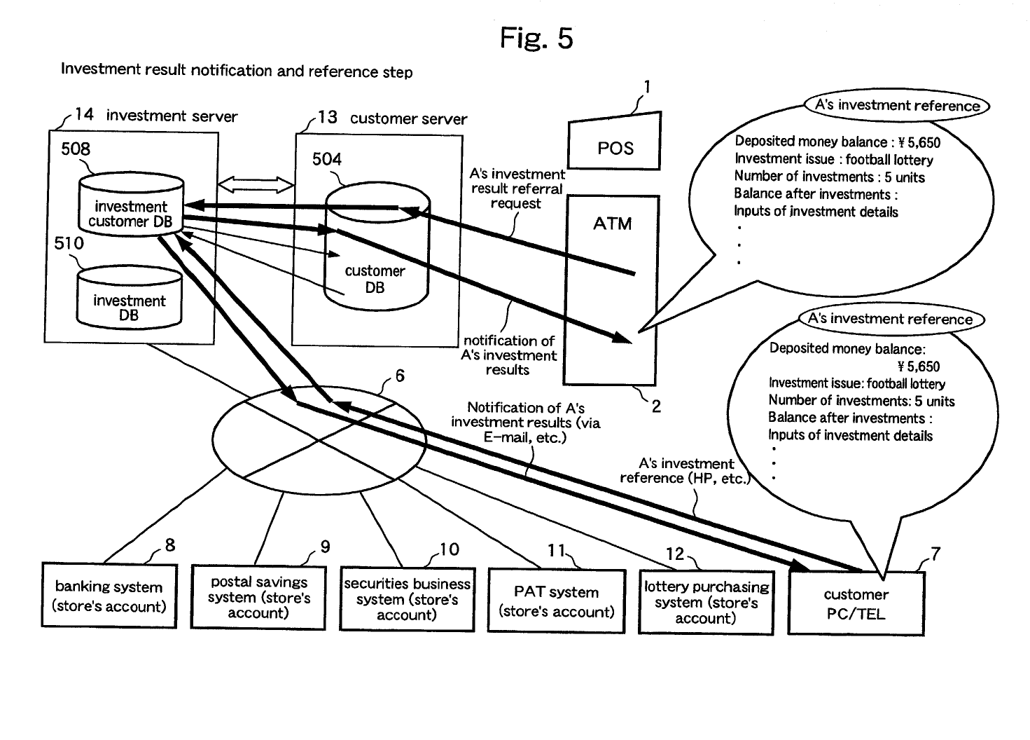

FIG. 5 conceptually illustrates an investment result notification and reference (inquiry) step. For instance, in case of the person A, he or she can know the investment results by accessing the investment server 14 through the customer server 13 from the ATM terminal 2 to confirm the data in the investment customer database 508. Moreover, the person A can know the investment results by directly accessing the investment server 14 from a customer terminal 7 through the network 6 to confirm the data in the investment customer database 508 and the customer database 504.

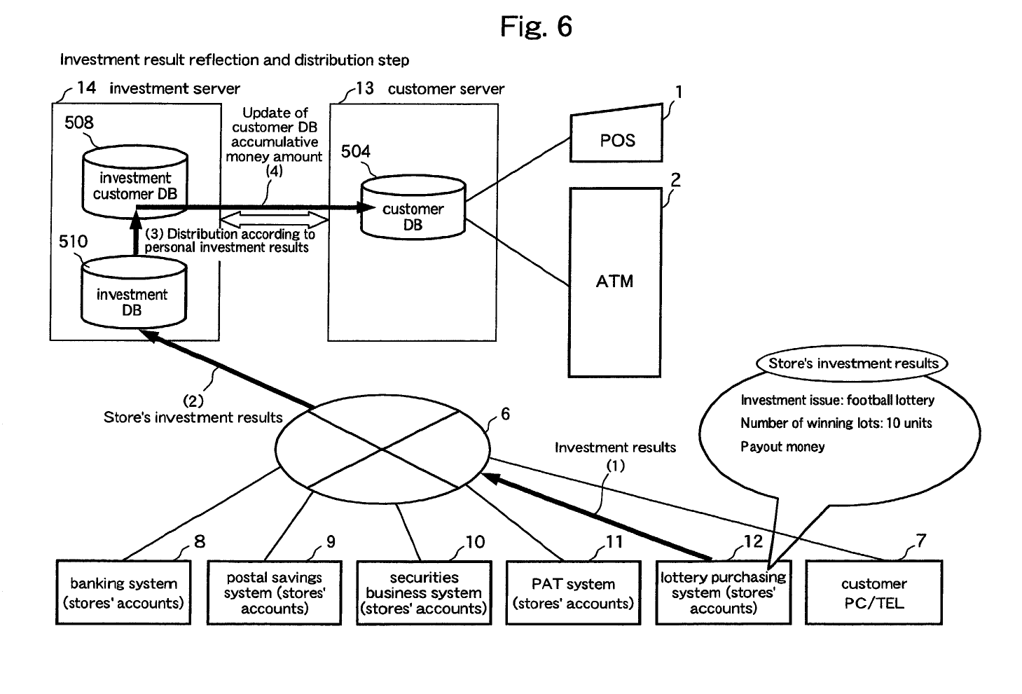

FIG. 6 conceptually illustrates an investment result reflection and distribution step for distributing returns on investments based on investment results. In this example, the investment results are reported from the lottery purchasing system 12 to the investment server 14 through the network 6, and the results thus reported are written or recorded into the investment database 510 as an amount of return (payout) money and a return per unit of investment. At the same time, the amount of return distributed to the customer A is determined based on the investment customer data (i.e., investment data of the customer A) in the investment customer database 508 related to the store's investment number in the investment database 510, and the results thereof are written or recorded into the investment customer data as the amount of payout money for instance. The distribution processing for such a distribution amount of return (payout) money is carried out by the return distribution processing part 513 of the administration part 506.

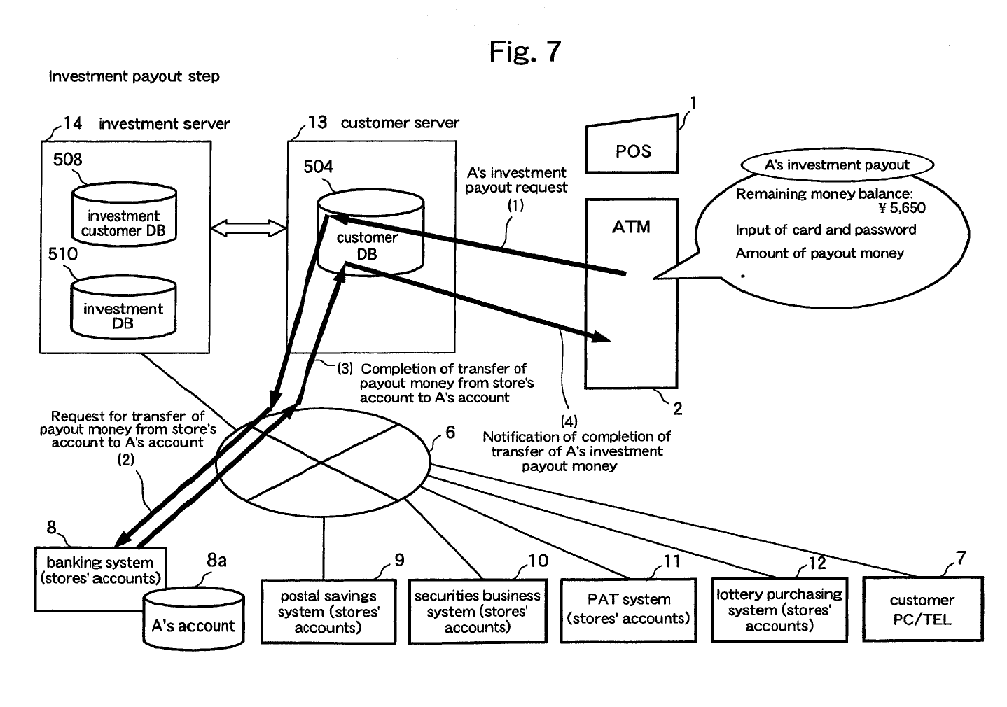

FIG. 7 conceptually illustrates a payout step for recovering investments. In this example, when the customer A makes a payout request at the ATM terminal 2, the customer server 13 demands that an amount of payout, which is the amount of money that the person A should receive as returns on investments from the A's account in the lottery purchasing system 12, is transferred to a bank account possessed by the customer A through the network 6. The amount of payout money corresponds to the amount of money written into the investment customer database 508. When the transfer has been completed, the result is transmitted to the ATM terminal 2 through the customer server 13. Incidentally, it is needless to say that such processing may be carried out from a customer terminal 7.

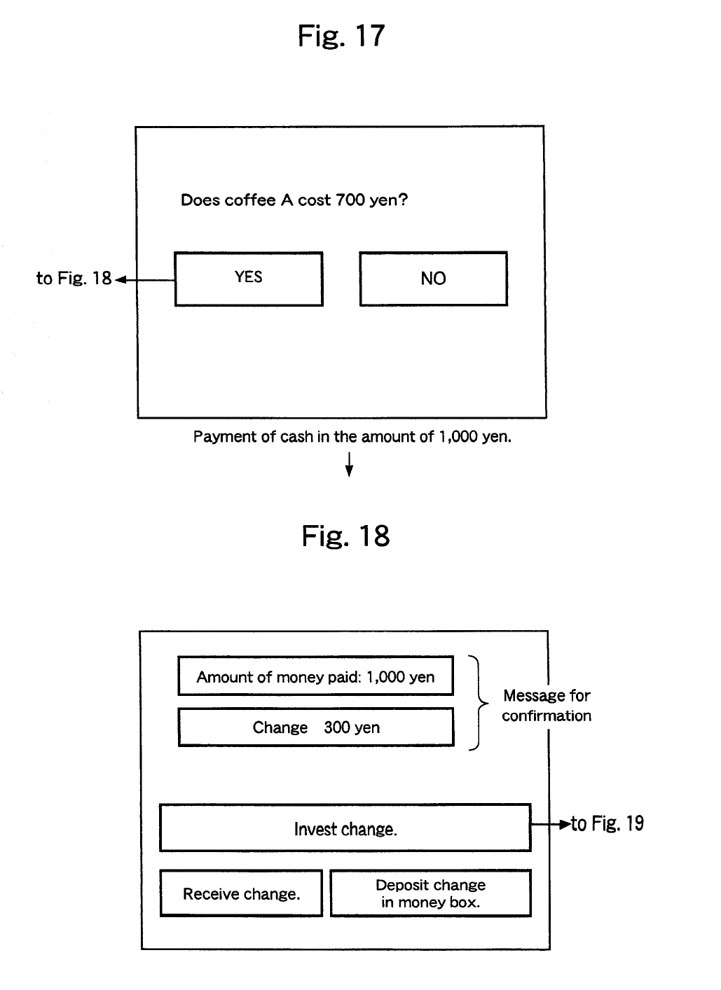

Another example of the above operation in which a lottery or a foreign currency is bought will be described below in some detail while using flow charts illustrated in FIG. 8 through FIG. 11 and ATM operation screens shown in FIG. 15 through FIG. 31. FIG. 8 is a flow chart showing a change data registration step (FIG. 3) and an investment step (FIG. 4). First, reference will be made to the case where goods or articles are bought with a change being generated. On an ATM operation starting screen shown in FIG. 15, there are provided a “beverage purchase” button and a “money (savings) box” button which are introduced according to the present invention in addition to existing processing buttons such as a “payment” button and a “deposit (paying-in)” button. When a customer operates or presses the “beverage purchase” button, a screen of FIG. 16 is displayed. When a “Coffee A 700 yen” button is operated or pressed in order for the customer to buy a coffee of 700 yen, a confirmation screen of FIG. 17 appears for confirmation of a purchase article. Here, upon pressing of “YES” on this confirmation screen, the process changes to a change investment request step (S802), and a change investment request screen as shown in FIG. 18 is displayed.

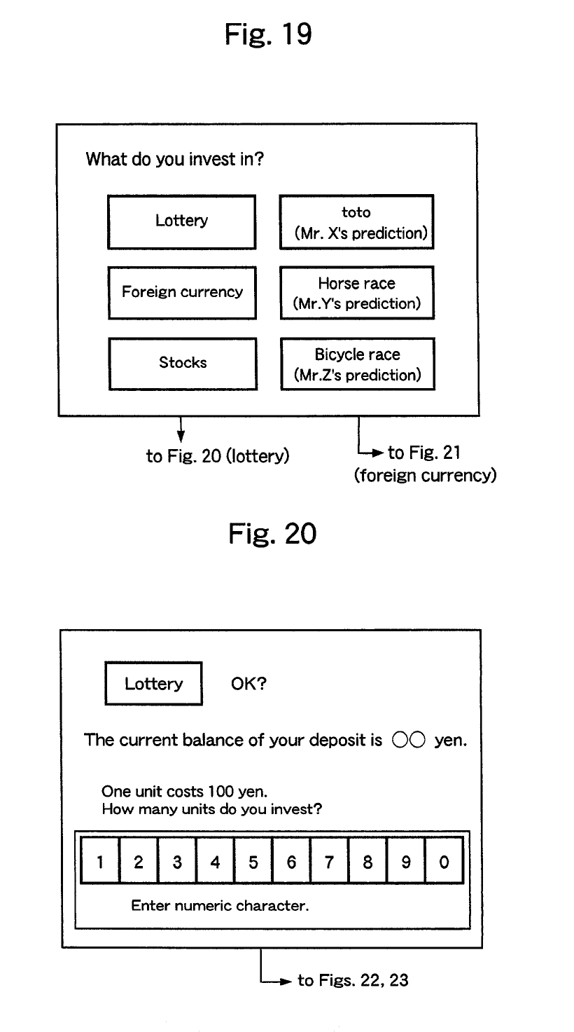

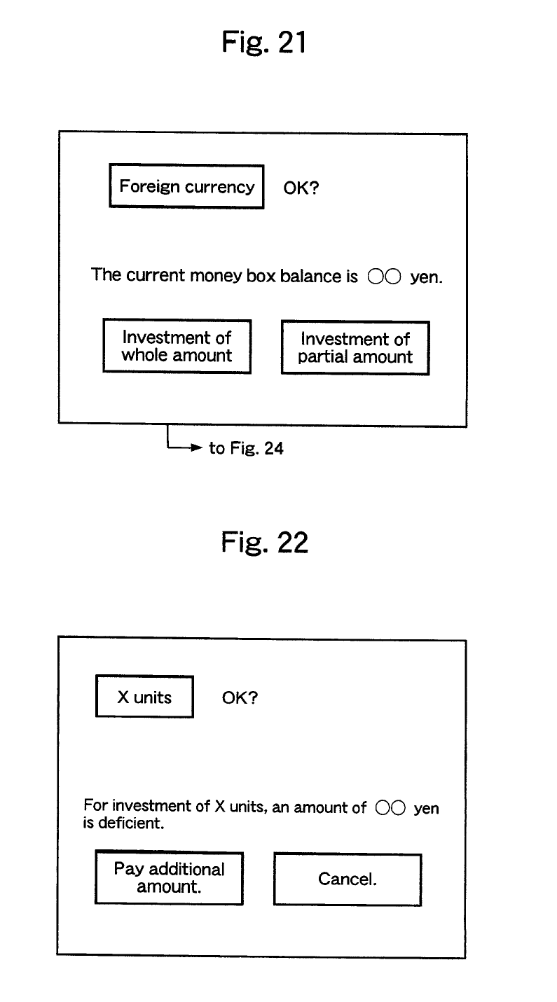

Here is shown the case where 1,000 yen is paid for the purchase of the coffee A of 700 yen. An inquiry about “Change is invested.” or “Change is paid back.” or “Change is deposited to the money box.” is displayed together with a confirmation message, “Change: 300 yen” for “Amount of payment: 1,000 yen”. Here, when “Change is invested” is pressed, the process proceeds to step S803 where the change (change data) is registered in the customer database 504. Subsequently, in step S804, an investment type selection screen of FIG. 19 is displayed so that the customer can select an investment issue (the kind or type of investment). In a sample shown in FIG. 19, “Lottery”, “Foreign currency”, “Stocks”, “Toto” (football lottery), “Horse race”, and “Bicycle race” are displayed as the types of investments. If “Lottery” is selected for instance (S804a), a unit entry or input screen of FIG. 20 is displayed, whereas if “Foreign currency” is selected (S804b), a selection screen of FIG. 21 is displayed. Thereafter, processing in step S805 is started.

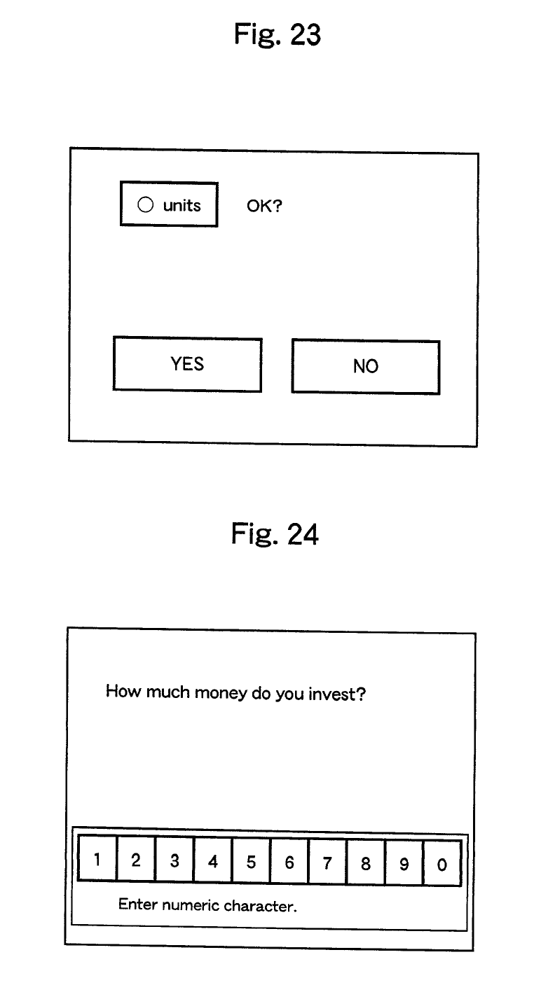

When the number of units to be invested is entered on the unit entry screen of FIG. 20, there appears a confirmation screen as shown in FIG. 23. On the other hand, when the amount of investment money for the indicated units of investments is deficient for the amount of money registered in the customer's account, a deficit indicating screen as shown in FIG. 22 is displayed so that there appear a “Pay additional amount.” button for adding the deficient amount of money and a “Cancel” button for canceling or stopping the investment. In addition, on the selection screen of FIG. 21, an indication is displayed for making a selection between “investment of whole amount” for investing the whole amount of registered money (money box balance) and “investment of partial amount” for investing a part of the amount of registered money. When “Investment of partial amount” is selected, an input screen for inputting or entering the amount of investment money is displayed, as shown in FIG. 24.

On the contrary, when no money is added to the deficient amount of money (S806, S806a), a return to step S805 is performed. Then, in order to input or enter the amount of money and units of investments again, the unit input or entry screen (FIG. 20) and the selection screen (FIG. 21) are displayed again as an amount of money re-entry or re-input screen and a unit re-entry or re-input screen, respectively (S807). When the deficient amount of money is added (S806, S806b), “Pay additional amount.” is selected in FIG. 22, and the customer database 504 is updated according to the resultant payment processing (S808), and the process proceeds to step S809. When the amount of registered money is not deficient (S806, S806c), the process immediately proceeds to step S809.

In step S809, investment processing is carried out, and the results of this processing are reflected on the investment customer database 508 and the investment database 510. At the same time, electronic data is transmitted to the respective investment destinations (investment-related management enterprise side systems), and an investment request is made using the electronic data. When the investment request has been completed, a screen indicating the completion of the investment processing is displayed as an investment request ending screen, as shown in FIG. 25. Additionally, an investment receipt as shown in FIG. 32 is printed out.

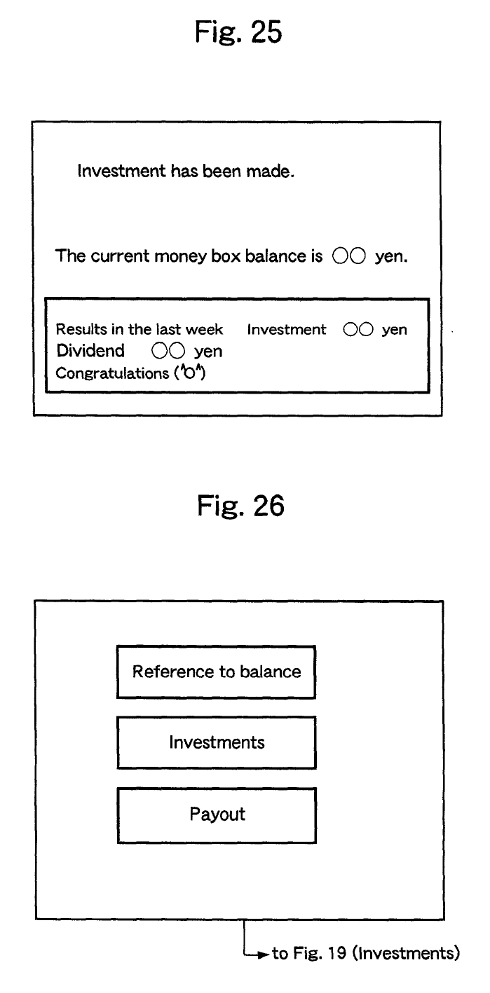

Here, note that an investment request is not made in step S802 (S802, NO), change payback processing is carried out (S811) and the process is ended. Further, when the customer selects the “money box” on the screen of FIG. 15 instead of the “beverage purchase” shown in step S801, a balance reference (inquiry) screen is displayed for indicating an updated balance of deposited money as shown in FIG. 26. In addition, when “Investment” is selected on the screen of FIG. 15 (S812), processing from step S804 is carried out.

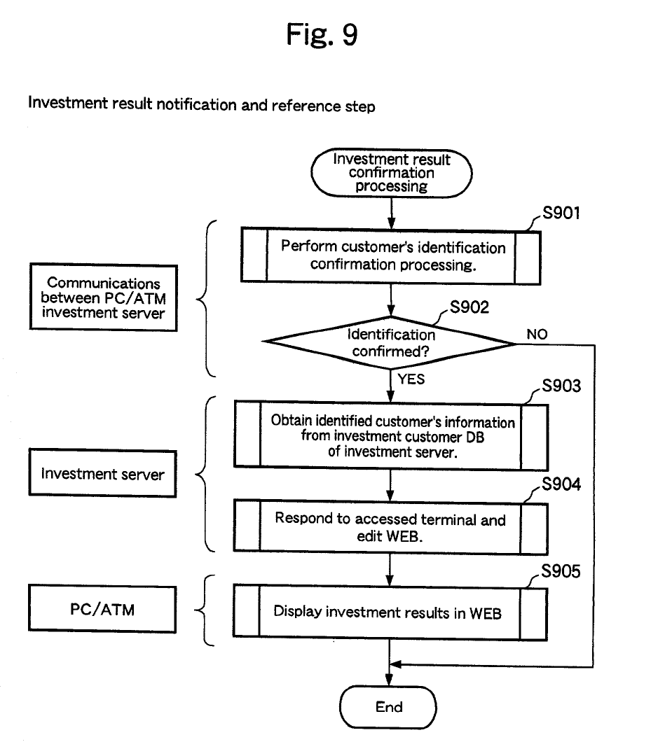

Next, the operation of an investment result notification and reference (inquiry) step will be described while using a flow chart of FIG. 9. In this step, personal identification processing is carried out in step S901 by using a password or the like for instance, in order to permit a customer to access the investment server 14 by the use of the ATM terminal 2 or a customer terminal 7. When the customer is identified or authenticated (S902, YES), the investment server 14 acquires change registration information data for the customer concerned from the investment customer database 508 (S903). Then, a Web corresponding to the accessed terminal is edited (3904), and the results thereof are displayed at the ATM terminal 2 or the customer terminal 7 concerned (S905).

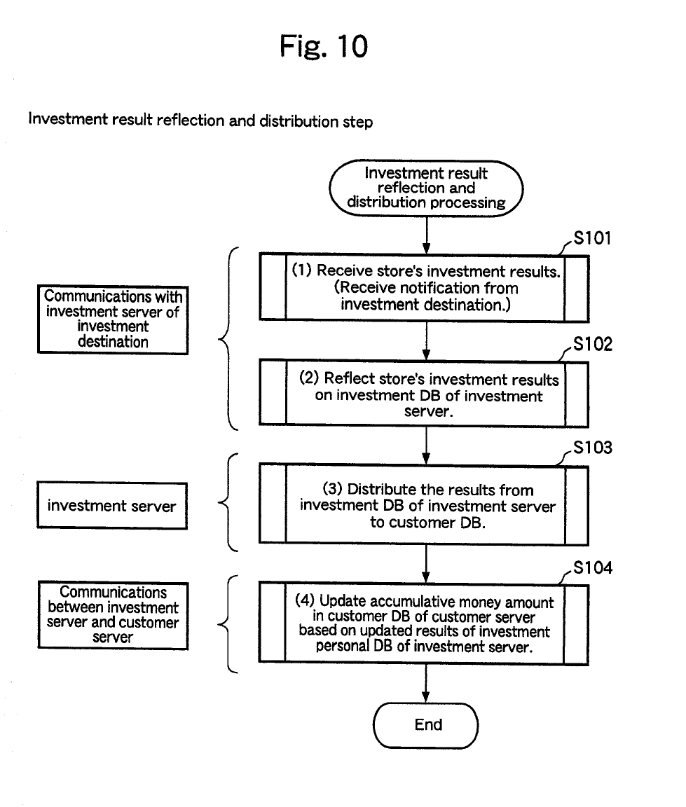

Now, the operation of an investment result reflection and distribution step will be described while using a flow chart of FIG. 10. This operation corresponds to the processing of updating the contents of the databases shown in FIG. 12 through FIG. 14. First of all, when the investment server 14 receives the results of investments of a store from an investment-related management enterprise side system (for instance, server)(step S101, (1) in FIG. 6), the results received are registered in the investment database 510 (step S102, (2) in FIG. 6). Simultaneous with this, the results of distribution of the store's investments are registered in the investment customer database 508 to perform an update thereof (step S103, (3) in FIG. 6 ). In addition, the results are reflected on the customer database 504 to update the contents thereof.

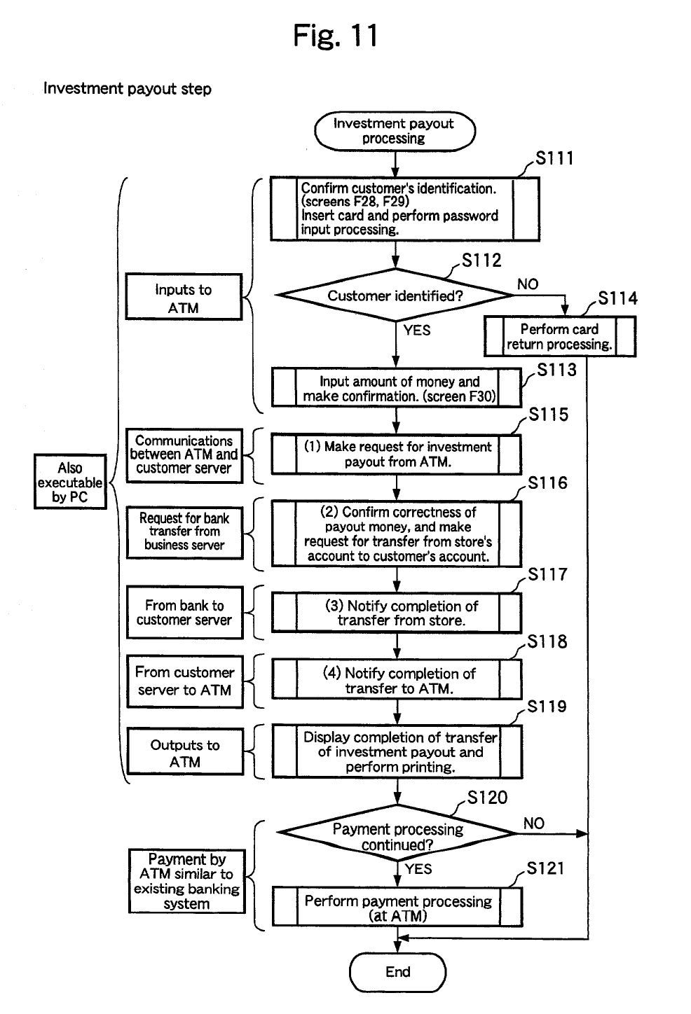

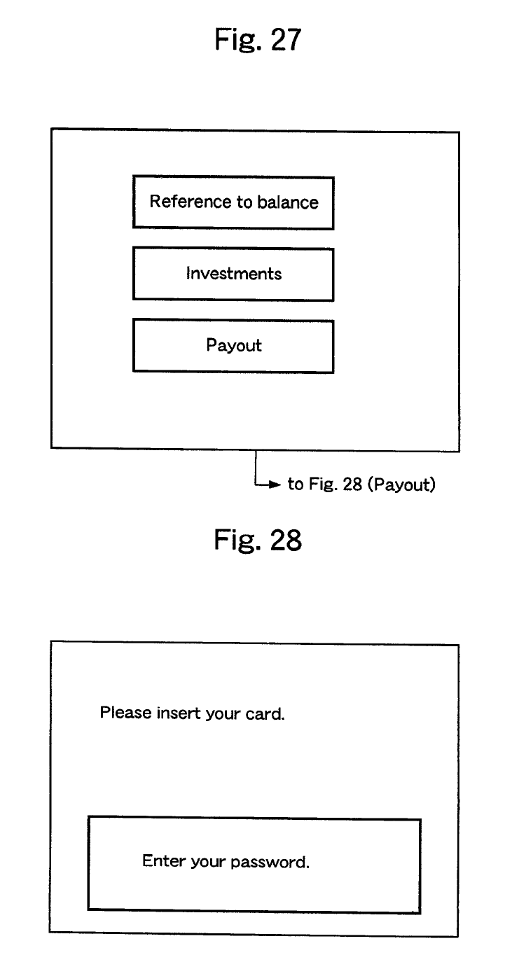

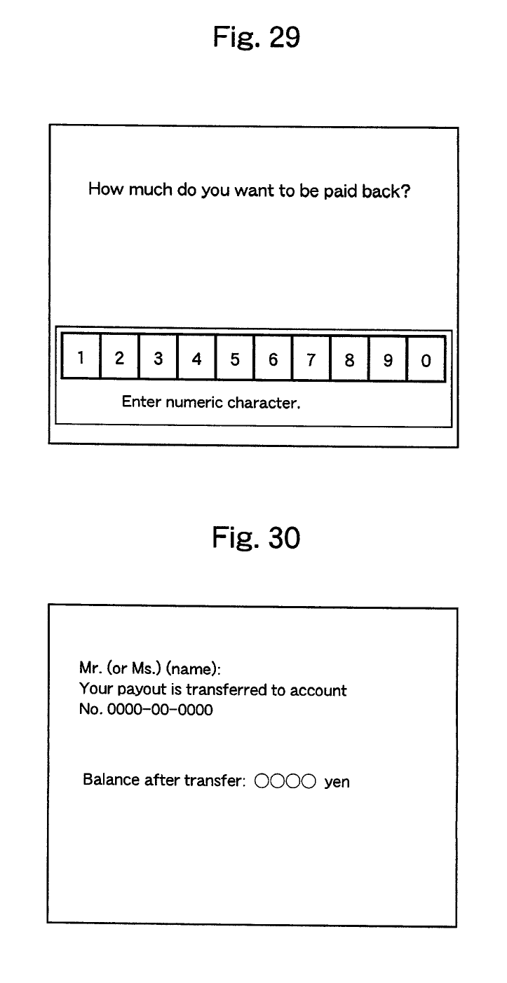

Next, the operation of an investment payout step will be described while using a flow chart of FIG. 11. This operation is started by pressing a “Payout” button for making a payout request on the balance reference (inquiry) screen of the ATM terminal 2 shown in FIG. 27. When the “Payout” button is pressed, there appears a screen of FIG. 28 on which a customer inserts his or her customer card and inputs a password (S111). When the customer is identified or authenticated (S112, YES), a payout amount input screen as shown FIG. 29 is displayed and the results are indicated as shown in FIG. 30. The results of the operation are transmitted to the customer server, and the payout processing is started in the customer server (S115, (1) in FIG. 7). The customer server requests that the transfer of money is performed as electronic data from the store's account concerned (investment-related management enterprise side system) to the customer's account (S116, (2) in FIG. 7).

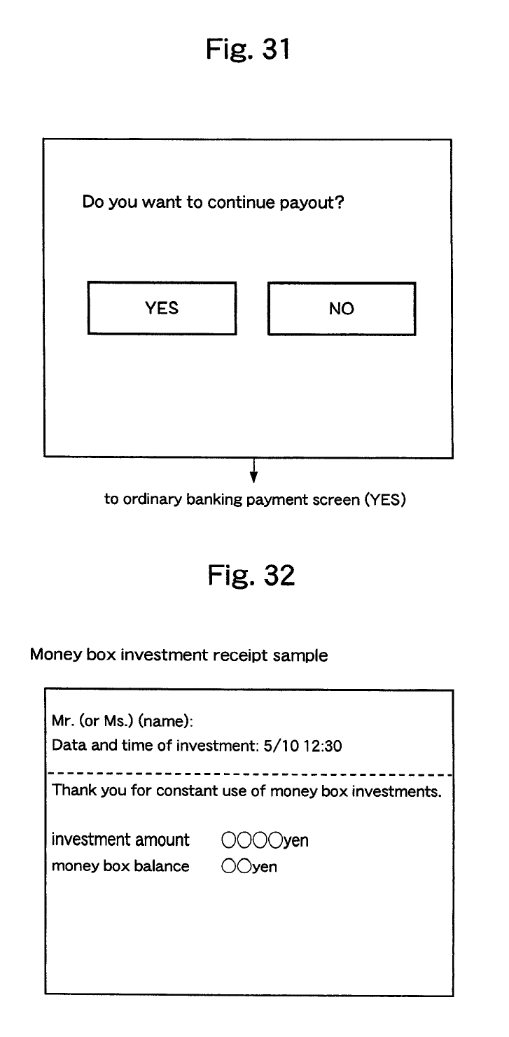

When the transfer to the customer's account has been made, this transfer from a bank office concerned is notified to the customer server (S117, (3) in FIG. 7), which in turn notifies the completion of the transfer to the ATM terminal 2 (S118, (4) in FIG. 7). At the ATM terminal 2, an indication of the transfer completion is made on its display screen, and a payout receipt as shown in FIG. 33 is printed out (S119). If the customer wants to have the amount of transferred money paid back, he or she presses a “YES” button on a continued payout processing screen as shown in FIG. 31 (S120, YES), whereby the ATM terminal 2 performs the payment processing as well-known in the conventional systems. On the other hand, if the customer presses a “NO” button on the continued payout processing screen (S120, NO), the process ends as it is.

In the embodiment described above in detail, a pooling of funds for change investments (joint or cooperative investments) has been described. Thus, even if the investment money (the amount of money to be paid in), the investment commission or the like for the change of each person becomes large, such a pooling of funds makes it possible to accordingly increase the number of investors, thereby enabling customers to easily perform highly profitable investments. As a result, in cases where funds for investments are pooled by a plurality of investors, returns on the investments are distributed to the investors according to the amount of money invested and the number of units of investments. On the other hand, an investment instruction (request) of each investor is placed in a state of waiting for an investment as long as the number of joint or cooperative investors for that investment reaches an appropriate value, and this waiting state is registered in appropriate items such as an item of the amount of investment request waiting money, etc., in the investment customer database 508. Although the above embodiment has explained a pooling of funds, it is needless to say that investments by a single investor can be made depending upon the kinds or types of investments, the amount of money to be invested, and available funds of the investor.

As described above in detail, according to the present invention, there are obtained the following advantages. That is, customers or purchasers can effectively utilize changes to be received for making investments, so that they can easily carry out the management of the changes. Accordingly, a change management system, a change management server, a change management method and a change management program can be provided which are capable of, enhancing the benefits and conveniences of the customers or purchasers as well as contributing to the activation of purchase dealings.

While the invention has been described in terms of a preferred embodiment, those skilled in the art will recognize that the invention can be practiced with modifications within the spirit and scope of the appended claims.

What is claimed is:

1. A change management system comprising:
a change data input part for inputting, as change data, data related to changes and persons who should receive the changes;
a change data registration part for registering the change data input by said change data input part; and
an investment processing part for performing prescribed investment processing using electronic data based on the change data registered by said change data registration part.

2. The change management system according to claim 1, wherein said investment processing part comprises:
an investment information data preparation part for preparing investment information data for prescribed investments based on the change data registered in said change data registration part; and
an administration part for administering the investment information data prepared by said investment information data preparation part.

3. The change management, system according to claim 2, wherein said administration part comprises an investment payment processing part for performing payment processing on investments by using electronic data based on said investment information data prepared by said investment information data preparation part.

4. The change management system according to claim 2, further comprising a management information instruction part for instructing management information on said changes, wherein said investment information data preparation part prepares said investment information data based on the change data registered in said change data registration part and the management information instructed by said management information instruction part.

5. The change management system according to claim 4, wherein said management information instruction part comprises a selection part for enabling the persons, who should receive the changes, to select, as investors, one or more investment types among a plurality of different investment types.

6. The change management system according to claim 5, wherein said plurality of investment types include savings, exchange purchases, stock purchases, horse race ticket purchases and lottery purchases.

7. The change management system according to claim 2, wherein said administration part comprises:
an investment information registration part for registering said investment information data; and
an investment payout processing part for paying out returns on the investments for recovery thereof based on the investment information data registered in said investment information registration part or said investment information data and prescribed instructions of the investors.

8. The change management system according to claim 7, further comprising a return distribution processing part for distributing data of amounts of money to be paid out by said investment payout processing part to a plurality of investors based on the investment information data registered in said investment information registration part.

9. The change management system according to claim 2, wherein said investment information data preparation part comprises a first change totaling part for totaling amounts of changes to be received by a prescribed person, and said investment information data preparation part prepares said investment information data based on a total sum of the changes totaled by said first change totaling part.

10. The change management system according to claim 2, wherein said investment information data preparation part comprises a second change totaling part for totaling said changes to be received by a plurality of different prescribed persons, and said investment information data preparation part prepares said investment information data based on a total sum of the changes totaled by said second change totaling part.

11. A change management system comprising:
a change data input terminal for inputting, as change data, data related to changes and persons who should receive the changes;
a change data registration database connected with said change data input terminal for registering therein the change data input by said change data input terminal;
an instruction information input terminal for inputting prescribed instruction information on the management of said changes; and
an investment processing server connected with said change data input terminal, said instruction information input terminal, said change data registration database, and an investment-related management enterprise side computer for performing the management of investments, said investment processing server being operable to perform prescribed investment procedures based on the change data registered in said change data registration database and instruction information input from said instruction information input terminal.

12. A change management server for managing changes through investments thereof, which is connected with an investment-related management enterprise side computer and an information terminal through a communications network for performing the management of investments,
said change management server comprising:
a registration part for registering, as change data, data related to changes and persons who should receive the changes, transmitted from said information terminal; and
an investment processing part adapted to access, upon receipt of prescribed instruction information on the management of said changes from said information terminal, said investment-related management enterprise side computer and perform investment processing by using electronic data based on said prescribed instruction information and the change data registered in said registration part.

13. A change management program for making a change management server, which is connected with an information terminal and an investment-related management enterprise side computer for the management of investments through a communications network, perform the processing of managing changes through investments thereof,
said program comprising:
a first step for registering data related to changes and persons who should receive the changes, transmitted from said information terminal in a registration part as change data;
a second step for accessing, upon receipt of prescribed instruction information on the management of said changes from said information terminal, said investment-related management enterprise side computer to perform investment processing by using electronic data based on said prescribed instruction information and the change data registered in said registration part; and
a third step for making said change management server perform said first and second steps.

14. A change management method for managing changes through investments thereof by using a computer and a communications network,
said change management method comprising the steps of:
registering data related to changes and persons who should receive the changes as change data;
receiving prescribed information on the management of the changes;
accessing an investment-related management enterprise side computer based on said prescribed information; and
performing prescribed investment processing on said investment-related management enterprise side computer by using electronic data based on said prescribed information on the management of the changes and said registered change data.

15. The change management method according to claim 14, wherein said step for performing prescribed investment processing comprises:
an investment information data preparing step for preparing investment information data for prescribed investments based on said information on the management of the changes and the registered change data; and
a payment processing step for performing payment processing on investments by using electronic data based on said investment information data prepared in said investment information data preparing step.

16. The change management method according to claim 15, further comprising:
an investment information registration step for registering said investment information data; and
an investment payout step for performing investment payout processing for recovery of investments by using electronic data based on said investment information data registered in said investment information registration step or said investment information data and said prescribed information.

17. The change management method according to claim 16, further comprising a distribution step for distributing data on the amounts of money paid out in said investment payout step to a plurality of investors based on said investment information data.

18. A change processing terminal equipment comprising:
a first selection part for permitting a person to make a selection as to whether a change, which is generated upon payment of an amount of money, is to be paid back or invested; and
a change processing part for performing prescribed processing to invest and manage said change when said first selection part makes a selection such that said change is managed through investments.

19. The change processing terminal equipment according to claim 18, further comprising a second selection part for permitting, upon the management of said change through investments being selected by said first selection part, the person to make a selection about the types of investments in response to the result of the selection of investments, wherein said change processing part performs prescribed processing on the management of the types of investments selected.

20. The change processing terminal equipment according to claim 18, wherein said prescribed processing is to transmit change data on the person who should receive said change and an amount of said change to a prescribed device which manages said change through investments.
